(19) United States
(12) Patent Application Publication
(10) Pub. No.: US 2005/0279889 A1
(43) Pub. Date: Dec. 22, 2005

(54) Variable wing spacecraft

(75) Inventor: Leonard M. Greene, White Plains, NY (US)

Correspondence Address: DENNISON, SCHULTZ, DOUGHERTY & MACDONALD, 1727 KING STREET, SUITE 105, ALEXANDRIA, VA, 22314, US

(73) Assignee: SAFE FLIGHT INSTRUMENT CORPORATION

(21) Appl. No.: 10/862,449

(22) Filed: Jun. 8, 2004

(51) Int. Cl. B64G 1/14

(52) U.S. Cl. 244/159.3

(57) ABSTRACT

A spacecraft having a fuselage, a severely swept back fixed wing and an extendible wing panel is disclosed. The extendible wing panel is rotatably extended after reentry into the atmosphere and is free of heat resistant tiles. Sensors and an algorithm are provided for preventing extension of the wing panels until after reentry.

### FIELD OF THE INVENTION

This invention relates to a spacecraft and more particularly to a spacecraft having an extendible wing segment for increasing the wing span of the spacecraft after reentry into the atmosphere.

### BACKGROUND FOR THE INVENTION

For reentry into the atmosphere a space-shuttle, spacecraft or space plane is covered with ceramic insulating material which are designed to protect it from heat buildup of approximately 3000° F. These materials include reinforced carbon-carbon on the wing surface and underside of the fuselage, high-temperature black surface insulating tiles on the upper forward fuselage and around the windows, white Nomax blankets on the upper payload doors, portions of the upper wing and mid and aft fuselage and low temperature white surface tiles on the remaining areas.

Then when reentry is successful, the spacecraft enters the main air of the atmosphere and is flown like an airplane until it reaches the ground. However, with its severely swept back wing, the final approach is at an angle of −20° which is about seven times steeper then the descent of a commercial aircraft.

It is now believed that the landing of a spacecraft can be improved by increasing the lift and stability of the spacecraft during the landing maneuver. In other words, the landing can be facilitated by increasing the wing area after reentry into the atmosphere. However, in any attempt to increase the lift and stability of the spacecraft during landing, it is important to minimize any increase in weight and provide protection against excessive heat buildup during reentry.

Variable wing aircraft for use in subsonic and supersonic flight are known. For example, a U.S. Pat. No. 4,181,277 of Gerhardt discloses a variable span wing which is a moveable segment mounted to slide along a trailing edge of a stationary main wing. Such wings may be suitable for supersonic and subsonic flight, but do not take into account problems of reentry into the atmosphere, excessive heat buildup during reentry into the atmosphere combined with a need to minimize weight and in so far as possible costs in a spacecraft.

### BRIEF SUMMARY OF THE INVENTION

In essence, the present invention contemplates a spacecraft having an extendible wing segment for increasing the lift and stability of the spacecraft after reentry into the atmosphere. The spacecraft includes a fuselage, a severely swept back fixed wing having an outer surface, a plurality of main engines and other conventional equipment. The spacecraft also includes heat resistant means such as ceramic tiles covering the fuselage and the outer surface of the fixed wing in a conventional manner. Such tiles are capable of withstanding the extreme high temperature created when the spacecraft enters the atmosphere at reentry speed. The spacecraft also includes a moveable wing panel extending outwardly from a rear portion of the fixed swept back wing after reentry into the atmosphere and wherein the outer surface of the wing panel is substantially free of heat resistant tiles.

In a preferred embodiment of the invention, the moveable wing panel is fully encased in a rear portion of the fixed wing when in its retracted position. For example, a tile covered door may be provided in a leading edge of the fixed wing for protecting the wing panel from excessive heat buildup during reentry into the atmosphere. Then after reentry, the doors may be opened to allow the wing panel to be rotated outwardly into an extended position for landing the spacecraft.

In the preferred embodiment of the invention means are also provided to prevent the extension of the wing panel until after reentry into the atmosphere. For example, means for rotating the wing panel into an extended position and for preventing premature extension of the wing panel may be based on speed, altitude and or deceleration of the spacecraft.

In a further embodiment of the invention, the moveable wing panel may have a leading edge which forms an extension of the severely swept back fixed wing when the wing panel is in a retracted position. In this embodiment, the leading edge of the wing panel is covered with heat resistant tiles since it would be exposed to the atmosphere during reentry. However, the upper and lower surfaces of the extendible wing panel are free of ceramic tiles and covered with a metal or alloy as in a conventional aircraft.

The invention will now be described in connection with the following figures wherein like reference numerals have been used to indicate like parts.

### DESCRIPTION OF THE DRAWINGS

FIG. 1 is a schematic top view of a spacecraft according to a first embodiment of the invention with its extendible wing panels in an extended position;

FIG. 2 is a schematic side elevational view of the spacecraft shown in FIG. 1;

FIG. 3 is a schematic front view of the spacecraft shown in FIGS. 1 and 2;

FIG. 4 is a schematic top view of the spacecraft shown in FIGS. 1-3 but showing the extendible wing panels in a retracted position;

FIG. 5 is a schematic front view of the spacecraft shown in FIG. 4;

FIG. 6 is a flow chart illustrating the steps or algorithm for actuating and/or preventing the extension of the wing panels; and

FIG. 7 is a flow chart illustrating the steps or algorithm for activating and/or preventing the extension of the wing panels in accordance with a further embodiment of the invention.

### DETAILED DESCRIPTION OF THE PREFERRED EMBODIMENTS OF THE INVENTION

Conventional spacecraft as for example the space shuttle include a fuselage which contains a crew compartment, support equipment, fuel cells and the like. A forward reaction control system containing jets for turning the craft, and other essential parts including gas tanks, a cargo door which is essential for cooling the craft and main engines are also provided. The spacecraft also includes a severely swept back fixed wing. Conventional spacecraft are also covered with high heat capacity insulating materials which are designed to protect the craft from a heat buildup of about 3000° F. due to friction during reentry into the atmosphere. The insulating materials include reinforced carbon-carbon tiles on the wing surfaces and on the underside of the fuselage, high-temperature black surface insulating tiles on the upper forward fuselage and around the windows and white Nomax blankets on the upper pay load doors and portions of the upper wing surfaces and parts of the fuselage. Low temperature white surface tiles are provided on other portions of the craft.

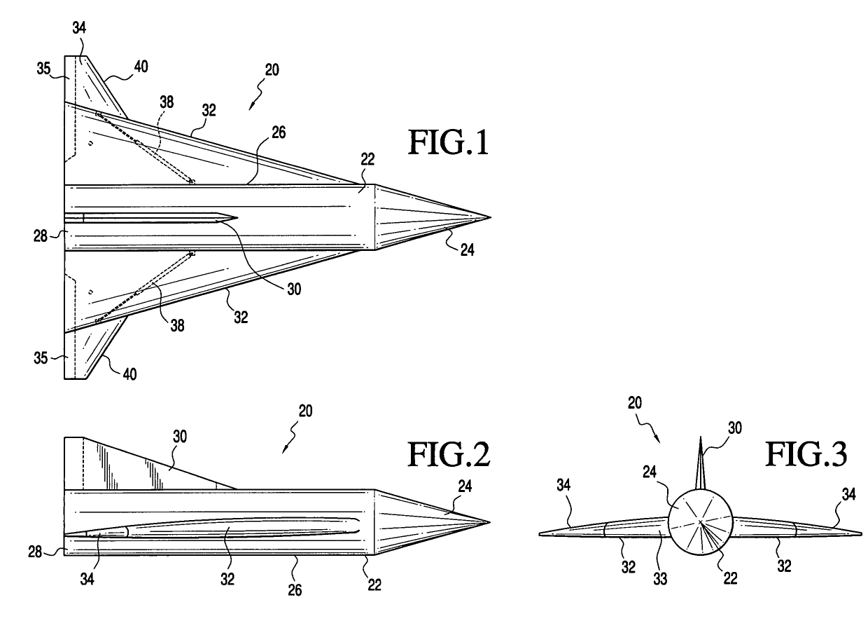

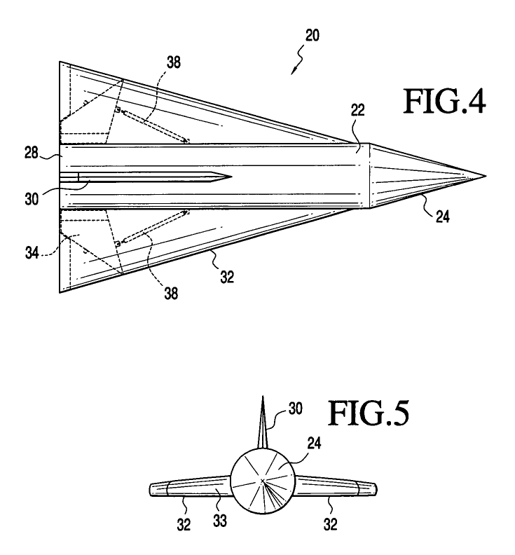

A spacecraft or space plane in accordance with the present invention includes many of the elements of a conventional space shuttle. For example, a spacecraft 20 as shown in FIGS. 1-5 include a fuselage 22 having a forward portion 24, mid portion 26 and aft portion 28 all of which may be of conventional design. As illustrated, the spacecraft 20 includes a ruder or vertical fin 30 and a pair of severely swept back rigid or fixed wings 32. Multiple engines (not shown) are in the aft portion of the craft.

An important feature in the present invention resides in a pair of extendible wing panels 34 which are pivotally extendible from an aft portion of the fixed wing 32. A pair of fluid or pneumatic cylinders 38 or other conventional means may be used to extend or rotate the extendible wing panels outwardly to increase the lift and stability of the aircraft during the landing maneuver.

In a preferred embodiment of the invention, the upper and lower surfaces and leading edge of the wing panels 34 are free of heat resistant tiles and are covered with a metal or alloy as used in conventional aircraft. Because the wing panels in a retracted position are fully encased within the fixed wing there is no need to protect the extendible wing portion from the high heat due to the friction during reentry into the atmosphere.

However, it is also contemplated that the wing panel 34 may each include a leading edge 40 which is covered by a high heat capacity ceramic or reinforced carbon-carbon tiles. In this embodiment, the upper and lower surfaces of the wing panels 34 are free of heat resistant tiles and are covered with a metal or alloy. In this embodiment the leading edges 40 are protected from the high heat due to friction during reentry into the atmosphere. This is due to the fact that the leading edges 40 forms an extension of the leading edge 33 of the fixed wing 32 and are therefore covered by a high heat capacity tiles.

It is also contemplated that the wing panels 34 include a control surface 35.

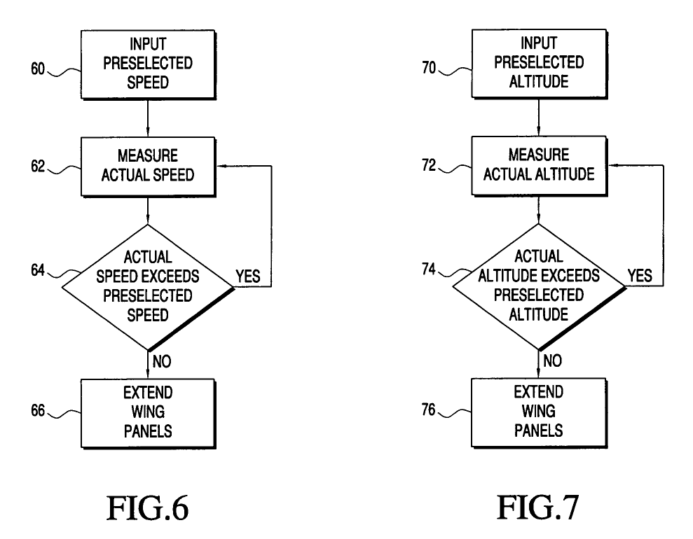

In FIG. 6, a flow chart illustrates the steps or algorithm for extending and/or preventing an extension of the wing panels 34. Means such as a computer may be used to extend the wing panels 34 after reentry into the atmosphere and to prevent the wing panels 34 from being extended until after the spacecraft has reentered the atmosphere. As illustrated a preselected airspeed at which the wing panels 34 can be safely extended is inputted into a computer in step 60 and the actual speed measured by any conventional means in step 62. The computer or the like compares the actual speed with the preselected speed in step 74. Then as long as the actual speed exceeds the preselected speed, the program recycles back to measure the actual speed. Finally, when the actual speed no longer exceeds the preselected speed the wing panels are extended in step 66.

An alternative flow chart for extending the wing panels is illustrated in FIG. 7. As shown therein, a preselected altitude is input into a computer in step 70 and the actual altitude measured in step 72. A computer then compares the preselected altitude in step 74 with the actual altitude and then when the actual altitude exceeds the preselected altitude, the program recycles back to step 72 and continues to measure the actual altitude which is continuously compared to the preselected altitude until the actual altitude is less then the preselected altitude. At this point, the wing panels are extended in step 76.

While the invention has been described in connection with its preferred embodiments, it should be recognized that changes and modifications may be made therein without departing from the scope of the appended claims.

1. A spacecraft comprising a fuselage and a severely swept back fixed wing having an outer surface, heat resistant means capable of withstanding the extreme high temperature created when the spacecraft enters the atmosphere at reentry speed covering said fuselage and said surface of said fixed swept back wing and a moveable wing panel extendible outwardly from said fixed swept back wing after reentry into the atmosphere and wherein said extendible wing panel is free of said means which are capable of withstanding the extreme high temperature created during reentry into the atmosphere.

2. A spacecraft according to claim 1 in which said wing panel is disposed in a rear portion of said severely swept back fixed wing when in a retracted position.

3. A spacecraft according to claim 2 in which said wing panel is fully enclosed by said fixed wing when in a retracted position.

4. A spacecraft according to claim 2 in which said wing panel includes a control element at a rear portion thereof when in an extended position.

5. A spacecraft according to claim 2 in which said wing panel forms a less severely swept back configuration then said fixed wing when in an extended position.

6. A spacecraft according to claim 2 in which said wing panel is rotatably extended outwardly from a retracted position to an extended position.

7. A spacecraft comprising a fuselage and a severely swept back fixed wing having an outer surface, high heat capacity tiles capable of withstanding the extreme high temperature created when the spacecraft enters the atmosphere at reentry speed covering said fuselage and said surface of said fixed wing and a pair of moveable wing panels moveable outwardly to extend the wing span after reentry into the atmosphere and wherein said wing panels are free of said high heat capacity tiles which are capable of withstanding the extreme temperature created during reentry into the atmosphere.

8. A spacecraft according to claim 7 which includes means for preventing extension of said wing panels until after reentry into the atmosphere.

9. A spacecraft according to claim 8 which includes means for rotating said wing panel outwardly from a rear portion of said fixed wing.

10. A spacecraft according to claim 9 in which said heat resistant means comprise a plurality of reinforced carbon-carbon tiles and ceramic tiles.

11. A spacecraft according to claim 10 in which said wing panels include upper and lower surfaces of a metal or alloy.

12. A spacecraft comprising a fuselage and a severely swept back fixed wing having an outer surface, heat resistant tiles capable of withstanding the extreme high temperature created when the spacecraft enters the atmosphere at reentry speed covering said fuselage and said surface of said fixed wing, and a moveable wing panel having a leading edge forming an extension of said severely swept back fixed wing when said wing panel is in a retracted position and said wing panel being moveably outwardly to extend the wing span after reentry into the atmosphere and wherein said leading edge of said wing panel is covered by said heat resistant tiles and wherein said extendible wing panels are otherwise free of said tiles which are capable of withstanding the extreme temperature created during reentry into the atmosphere.
